(19) United States
(12) Patent Application Publication
(10) Pub. No.: US 2013/0326607 A1
(43) Pub. Date: Dec. 5, 2013

(54) Method, Apparatus and System of Controlling Remote Login

(71) Applicant: Alibaba Group Holding Limited, Grand Cayman (KY)

(72) Inventor: Liang Feng, Hangzhou (CN)

(21) Appl. No.: 13/909,903

(22) Filed: Jun. 4, 2013

(30) Foreign Application Priority Data
Jun. 5, 2012 (CN) 201210183683.X

(51) Int. Cl. H04L 29/06

(52) U.S. Cl. CPC H04L 63/10
USPC 726/7

(57) ABSTRACT

The disclosure provides a multiple location login control method, device, and system. The method may include receiving, by a server, login information recorded for a current login, wherein the login information includes a login ID, a first login time, and a first geographic location of a client for the current login. The login information for the previous login for this login ID is obtained to acquire a second geographic location and second login time of the client at a previous login. The server may calculate a speed of movement based on the two login times and the two geographic locations. When the speed of movement exceeds a preset speed, the server may determine that the current login is an invalid multiple location login.

### CROSS REFERENCE TO RELATED PATENT APPLICATIONS

This application claims priority to Chinese Patent Application No. 201210183683.X, filed on Jun. 5, 2012, entitled “Method, Apparatus and System of Controlling Remote Login,” which is hereby incorporated by reference in its entirety.

### TECHNICAL FIELD

This disclosure relates to the Internet field, and more specifically, to a multiple location login control method, device, and system.

### BACKGROUND

With the rapid development and widespread popularization of mobile Internet, users may not log in at a fixed geographic location. Given current security problems for mobile Internet, a user may not be the valid owner of an account while successfully logging into the account. This is a type of invalid login manner in a multiple-location login process.

To solve these issues, existing technologies often determine whether there is a login session in the system that is unique to a user ID of a client after the server receives a login request using the user ID. If there is such a session, the system will assume that the entity login using this user ID is an invalid user, and thus deny the login. On the other hand, if there is no such session, the system will assume that the user is a valid user, and thus allow the login.

To a certain extent, this scheme used in existing technologies solves problems associated with multiple-location login. The existing technologies assume: as long as there is already a preexisting login session when a user logs in, the user's login should be denied. Therefore, if the user is a valid user while logging in from a different location, this scheme is flawed because it makes it impossible for valid users to conduct a normal login from different locations. For example, if a user gets disconnected after the previous login, the user may be unable to log in again because the previous login session has not yet expired.

In addition, some existing technologies may record the geographic location from which the user typically logs in. Once a login with a geographic location exceeding a certain distance is discovered, it is determined to be a multiple location login. However, these technologies still fail to accurately and effectively eliminate multiple location logins by valid users. For example, it is normal for a user to travel to a geographic location beyond a certain distance and to log in. If the existing technologies are used to determine a multiple location login, it may result in unnecessary alerts. This makes it impossible to set up automated, temporary, and restrictive measures.

Based on the preceding analysis, at the present time, no effective solutions have addressed the flaws in existing technologies of misjudgments in detecting multiple location logins, which leads to the problem of valid users being unable to normally execute multiple location logins.

### SUMMARY

At the present time, no effective solutions have addressed the flaws in existing technologies of misjudgments in detecting multiple location logins, which leads to the problem of valid users being unable to normally execute multiple location logins.

Embodiments of this disclosure relate to a multiple location login control method. The method may include receiving, by a server, the login information recorded for a current login, wherein the login information includes: a login ID, a first login time, and a first geographic location of a client for a current login. The server may query the login information for a previous login for this login ID in order to acquire a second geographic location and second login time of the client at the previous login. The server may calculate a speed based on the two login times and the two geographic locations acquired following the two logins. The speed of movement between the two logins may be represented using a physical shift. When the speed of movement exceeds a preset speed, the server may determine the current login to be invalid.

In some embodiments, prior to receiving the login information recorded for the login, the method may also include acquiring geographic location information through a geographic location positioning device on a client terminal associated with the client. In some embodiments, the server may read the client IP address and then query an IP geographic location database using the client IP address to acquire the geographic location of the client.

In some embodiments, the servers may also confirm a login range for the current login based on the client's geographic location information acquired during the two logins. The server may acquire the preset speed corresponding to the login range of the current login, and then compare the preset speed with the abovementioned speed of movement. When the speed of movement exceeds the preset speed, the server may determine or confirm that that the current login is an invalid multiple location login.

In some embodiments, the server may also determine whether the login range of the current login is located within a preset first login region. When the login range is located within the preset first login region, an assessment is made as to whether or not the speed of movement exceeds the first preset speed. When the speed of movement exceeds the first preset speed, the server may determine that the current login is an invalid multiple location login. In some embodiments, when the login range is located outside of the preset first login region, an assessment is made as to whether or not the login range of the current login is located at a preset second login region. When the login range is located within the preset second login region, an assessment is made as to whether or not the speed of movement exceeds the second preset speed. When this speed of movement exceeds the second preset speed, the server may determine or confirm that the current login is an invalid multiple location login.

In some embodiments, when the login range is located outside of the preset second login region, an assessment is made as to whether or not the speed of movement exceeds a third preset speed. When the speed of movement exceeds the third preset speed, the server may determine or confirm that the current login is an invalid multiple location login.

In some embodiments, the geographic location positioning device is a Global Positioning System (GPS) chip or a World Wide Web Consortium (W3C) geographic location positioning module.

Embodiments of this disclosure also relate to a multiple location login control device. The device may include an acquisition module configured to receive the login information recorded for a current login, wherein the login information includes: a login ID, a first login time, and a first geographic location of a client for the current login. The device may also include a query module configured to query the login information for a previous login for this login ID in order to acquire a second geographic location and second login time of the client at the previous login. The device may also include a calculation module configured to conduct a speed calculation based on the two login times and the two geographic locations acquired following the two logins to find the speed of movement during the two logins (e.g., the physical shift). The device may also include a processing module configured to confirm that the current login is an invalid multiple location login when the speed of movement exceeds a preset speed.

In some embodiments, the device may include a determination module configured to determine or confirm a login range based on the client's geographic locations acquired during the two logins. The device may include a first assessment module configured to determine whether or not the login range of the current login is located within a preset login region, and to acquire the preset speed corresponding to the current login range. The device may include a second assessment module configured to determine whether or not the speed of movement exceeds the preset speed. When the speed of movement exceeds the preset speed, the server may determine or confirm that the current login is an invalid multiple location login.

Embodiments of this disclosure also relate to a multiple location login control system. The system may include the multiple location login control devices described above, and a client terminal configured to send recorded login information after a login.

In some embodiments, the client may include a geographic location positioning device configured to acquire the geographic location of the client at a time of login, and/or a processing device configured to read the IP address of the client and to conduct a query of the IP geographic location database based on the client's IP address to acquire the geographic location of the client.

In some embodiments, a server may receive the login information recorded for the current login, wherein the login information includes: a login ID, a first login time, and a first geographic location of a client for a current login. The server may query the login information for a previous login for this login ID in order to acquire the second geographic location and second login time of the client at the previous login. Also, a speed calculation may be conducted based on the two login times and the two geographic locations acquired following the two logins to find the speed of movement for the two logins (e.g., the physical shift). When a speed of movement exceeds a preset speed, the server may determine or confirm that the current login is an invalid multiple location login. In some embodiments, after the client's geographic locations for the two logins are acquired, the server may determine whether or not the speed of movement along the linear distance between the two login locations exceeds a speed limitation. If the speed of movement exceeds the speed limitation, the current multiple location login user is deemed to be an invalid user. Thus, embodiments of the disclosure solve the flaws in existing technologies of misjudgments in detecting multiple location logins. Furthermore, the embodiments improve the accuracy with which a determination is made regarding the validity of a multiple location login user, therefore ensuring security for multiple location logins.

This Summary is not intended to identify all key features or essential features of the claimed subject matter, nor is it intended to be used alone as an aid in determining the scope of the claimed subject matter.

### BRIEF DESCRIPTION OF THE DRAWINGS

The Detailed Description is described with reference to the accompanying figures. The use of the same reference numbers in different figures indicates similar or identical items.

FIG. 1 shows a structural diagram of a device for a multiple location login control.

FIG. 2 shows a flowchart for a multiple location login control.

FIG. 3 shows another flowchart for a multiple location login control.

### DETAILED DESCRIPTION

The embodiments of this disclosure and the features of these embodiments may be combined with each other when there are no conflicts. Below is a detailed description of certain example embodiment of this disclosure referring to the attached figures.

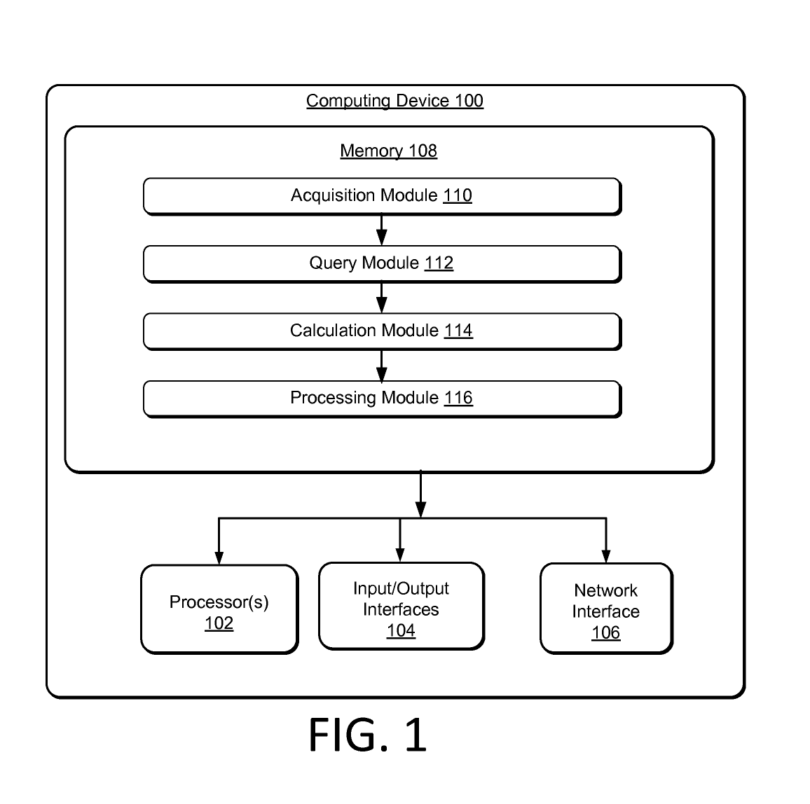

FIG. 1 shows a structural diagram of a device for a multiple location login control. FIG. 1 illustrates an example of a computing device 100. The computing device 100 may be a user device or a server for a multiple location login control. In one exemplary configuration, the computing device 100 includes one or more processors 102, input/output interfaces 104, network interface 106, and memory 108.

The memory 108 may include computer-readable media in the form of volatile memory, such as random-access memory (RAM) and/or non-volatile memory, such as read only memory (ROM) or flash RAM. The memory 108 is an example of computer-readable media.

Computer-readable media includes volatile and non-volatile, removable and non-removable media implemented in any method or technology for storage of information such as computer readable instructions, data structures, program modules, or other data. Examples of computer storage media include, but are not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. As defined herein, computer-readable media does not include transitory media such as modulated data signals and carrier waves.

Turning to the memory 108 in more detail, the memory 108 may include an acquisition module 110, a query module 112, a calculation module 114, and a processing module 116. The acquisition module 110 is configured to receive the login information recorded for a current login, wherein the login information includes: a login ID, a first login time, and a first geographic location of a client for the current login.

The query module 112 is configured to query the login information for a previous login for this login ID in order to acquire a second geographic location and second login time of the client of the previous login. The calculation module 114 is configured to conduct a speed calculation based on the two login times and the two geographic locations acquired following the two logins to find the speed of movement for the two logins (e.g., the physical shift). The processing module 116 is configured to determine or confirm that the current login is an invalid multiple location login when the speed of movement exceeds a preset speed.

In some embodiments, the acquisition module 110 is on a server and is used to acquire a client terminal's geographic locations and login times for logins that a user employs the same login ID twice to login from different locations. The client terminals of the two logins may be the same client terminal or different client terminals. In some embodiments, after the client's geographic locations for the two logins are acquired, the two login times and geographic locations acquired are used to conduct a speed calculation. Furthermore, a difference between the first and the second geographic location as well as a difference between the first and second login times are found. Then, the location difference is divided by the time difference to acquire the speed per hour of movement along the linear distance between the two login locations. The server may determine whether or not the speed per hour of movement along the linear distance between the two login locations exceeds a speed per hour limitation. If the speed exceeds the limitation, the current multiple location login user is deemed to be an invalid user. This is because the speed per hour of movement for a valid user would not exceed the speed per hour limit. Thus, embodiments of this disclosure solve the flaws in existing technologies of misjudgments in detecting multiple location logins. Furthermore, embodiments of this disclosure improve the accuracy with which a determination is made regarding the validity of a multiple location login user, therefore ensuring security for multiple location logins.

User login activities in the embodiments of this disclosure may be the user logging in to disclosure software installed on the client terminal. In some embodiments, a login interface on a webpage on the client may be provided. However, login modes are not limited to the login modes described above. In some embodiments, other modes, such as server access logins and other hardware logins, may also be provided.

In some embodiments, when a server determines that a multiple location login is invalid, the server may send an alert to an owner of the login account or temporarily activate an automatic screening of key functions and concealment of sensitive data. In some instances, the server may prohibit the login until there is a personal confirmation or authorization by the account owner.

In some embodiments, the device may also include a determination module that is configured to confirm a login range based on the client's geographic locations acquired for the two logins. The device may also include a first assessment module that is configured to assess whether or not the login range of the current login is located within a preset login region to acquire the preset speed corresponding to the current login range. The device may also include a second assessment module that is configured to assess whether or not the speed of movement exceeds the preset speed. When the speed of movement exceeds the preset speed, the server may determine or confirm that the current login is an invalid multiple location login. In these instances, after the geographic locations of the client for the two logins are confirmed, the client's current login range is confirmed based on the geographic locations. There are preset speeds for every login range. In other words, theoretical speed limits for speeds of movement have been set for every login range. Therefore, after the login range is determined, when the speed of movement is detected to exceed the preset speed, the server may determine or confirm that the mobile user of the current login client is an invalid user.

In some embodiments, the preset speeds defined for every login range in the embodiments of this disclosure may be based on geographic movements of current vehicles. For example, a speed limit for city roads in China is 80 km/h, a speed limit for highways is 120 km/h, and the maximum speed for civilian aircraft is 900 km/h. Therefore, if the account owner's speed of movement along a straight line from a previous login location to a current login location exceeds the abovementioned speed limits, the multiple location login may be deemed to be invalid.

In some embodiments, it is possible that the account owner provides someone else with their login ID and password, and it is also possible that the login ID and password of the account owner are being illegally used. Thus, a multiple location login needs to be promptly communicated to the account owner, and the system must promptly adopt temporary screening, concealing, and prohibiting measures in order to ensure account security.

The multiple location login control may be implemented using a server with data processing capabilities. This disclosure may provide a multiple location login control system based on this server. In addition to including the abovementioned multiple location login control device, this system may also include a client terminal that is used to send the recorded login information after a login.

The client in the abovementioned embodiments of this disclosure may include a geographic location positioning device that is configured to acquire the geographic location of the client at the time of the login. In some embodiments, the server may include a processing device that is configured to read the IP address of a client and to conduct a query of the IP geographic location database based on the client's IP address to acquire a geographic location of the client. In some instances, the geographic location positioning device is a GPS chip or a W3C geographic location positioning module, wherein the processing device may include a CPU processor.

Embodiments may be implemented during a process of acquiring geographic location information. These embodiments may rely upon the client's function modules present in current login application software. When a geographic location positioning device is installed on the client terminal (e.g., a mobile device GPS chip), it is possible to use this GPS chip to acquire the latitude and longitude of the current geographic location of the client. When a GPS chip is not installed on the client, it is possible to employ a browser supporting the W3C Geolocation standard to acquire the current geographic location of the client when the user logs in using application software. In addition, it is possible to search for the IP address of the current login terminal in an IP geographic location database to acquire the geographic location of the user at the time of login.

In some embodiments, mobile devices (e.g., smart phones and tablets) have an internal GPS chip, and therefore it is possible for an application program to acquire the login location's latitude and longitude during a login process. In addition, some recent Web browser versions support the W3C Geolocation standard (e.g., geographic location positioning standard). The browsers may use the W3C Geolocation API to acquire the latitude and longitude of the client's location during the process of logging-in using application software. In some embodiments, there is no GPS chip and the browser does not support the W3C Geolocation standard. In these instances, a website may obtain the latitude and longitude of the location of an application login using an IP geographic location database (e.g., MaxMind GeoIP) and an IP address of the login client.

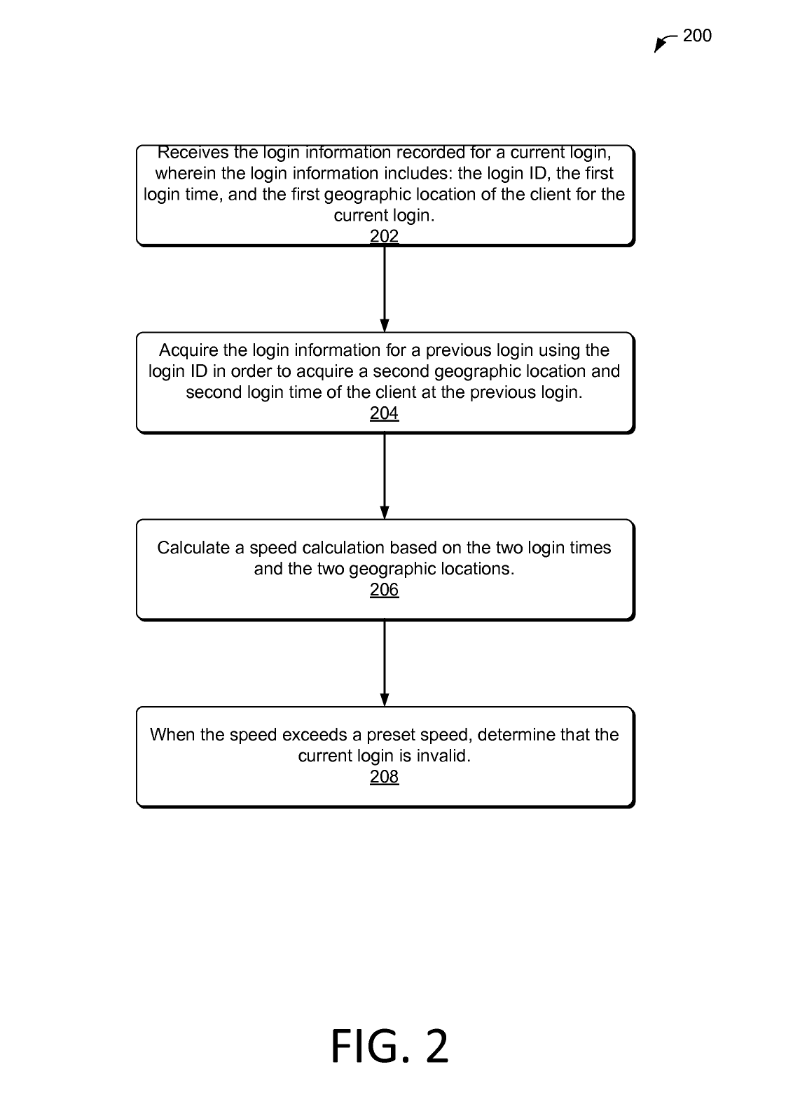

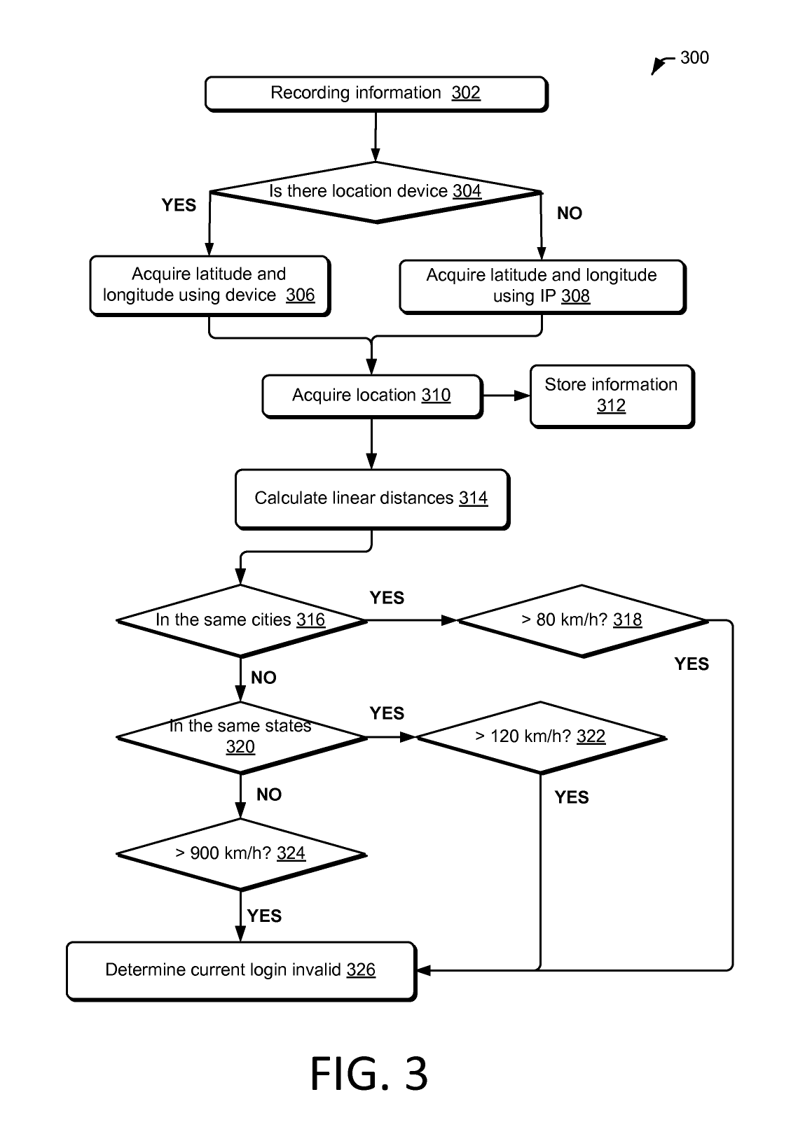

FIG. 2 shows a flowchart for a multiple location login control. FIG. 3 shows another flowchart for a multiple location login control using the device shown in FIG. 1. As shown in FIG. 2, at 202, the server uses the acquisition module 110 to receive login information recorded for current login, wherein the login information includes a login ID, a first login time, and a first geographic location of a client for the current login. At 204, the server uses the query module 112 to look up the login information for a previous login for this login ID to acquire a second geographic location and second login time of the client at the previous login.

At 206, the server may use the calculation module 114 to calculate a speed based on the login times and geographic locations acquired after two logins to find the speed of movement for the two logins (e.g., the physical shift). At 208, the processing module 116 may confirm that the current multiple location login is an invalid multiple location login when the speed of movement exceeds the preset speed.

In some embodiments, after a user employs the same login information to login twice from different locations, the geographic locations and login times of the client terminal for the two logins are acquired. Then, a speed calculation is conducted based on the two acquired login times and geographic information, and a speed of movement along the linear distance between the two login locations is determined. The server may also detect whether or not the speed of movement along the linear distance between the two login locations exceeds the speed limit. If the speed of movement exceeds the speed limit, the current multiple location login user is deemed to be an invalid user. The system assumes that the speed of movement for a valid user would not exceed the speed limit. Thus, embodiments of this disclosure solve the flaws in existing technologies of misjudgments in detecting multiple location logins. The flaws lead to a problem of valid users being unable to normally execute multiple location logins. Furthermore, embodiments of this disclosure improve the accuracy with which a determination is made regarding the validity of a multiple location login user, therefore ensuring security for multiple location logins.

In addition, embodiments of this disclosure take into full consideration reasonable speeds of movement in reality. In some embodiments, the server will not trigger a false alarm no matter how far the user travels. However, if a multiple location login indicates an unreasonable speed of movement, a relatively accurate assessment will be made of whether the current multiple location login is the operation of a valid user even though the two locations are close together. If the multiple location login is invalid, the system may automatically set temporary restrictive measures.

In combination with FIGS. 2 and 3, the following gives a detailed description of embodiments of this disclosure. As illustrated in FIG. 3, at 302, the system automatically records information such as a login time and an IP address when a client user logs in to an application. At 304, the client terminal confirms whether a geographic location positioning device is installed. In other words, the system may detect whether the client terminal is equipped with a GPS chip or a browser that supports the W3C Geolocation standard. If there is a location device, the operation goes to 306. If there is not location device, the operation goes to 308. At 306, the client terminal acquires the latitude and longitude of the device using the location device.

At 308, the client terminal searches the recorded IP address in an IP geographic location database to acquire a geographic latitude and longitude corresponding to the IP address of the current client login. At 310, the geographic location positioning device is used to acquire the latitude and longitude of the client's current geographic location. At this point, the user logs in to the current client application.

In some embodiments, before the server receives the login information recorded for an application login, the client's geographic location positioning device acquires geographic location information. In some embodiments, the client's IP address is read, and then a query is conducted in an IP geographic location database using the client's IP address to acquire the geographic location of the client (e.g., a latitude and longitude of the client's geographic location). In some instances, the geographic location positioning device is a GPS chip or W3C geographic location positioning module.

Some embodiments of this disclosure use a mobile device GPS chip or a browser that supports the W3C Geolocation standard to acquire the geographic location of the client at the time of user login. Embodiments of this disclosure also may look up the IP address of the current client at the time of user login in an IP geographic location database to acquire the geographic location of the current client.

At 310, the server may obtain information (e.g., a city, province, autonomous region, or state) associated with a current location of a user based on the client's login IP address and the IP geographic location database. In some embodiments, a login range for the two application logins is acquired. At 312, the login time, IP address, latitude and longitude, city, province, autonomous region, and/or state are stored.

At 314, the system may acquire the geographic locations and login times of the two logins to calculate the linear distance between the two locations based on the latitude and longitude of the current and previous login location. The server may calculate the time difference between the two locations based on the current and previous login times, and it may calculate the speed of the linear movement between the two locations (e.g., the physical shift).

At 316, the server may determine a login range for the logins in these two different locations based on the city, province, autonomous region, and/or state of the user's location during the two application logins. If the two logins are in the same city (i.e., operation 316), the operation goes to 318. At 318, an assessment is made as to whether a speed of movement between the two logins exceeds a predetermined value (e.g., 80 km/h). If so, the operation goes to 326.

At 320, the login range for the two multiple location logins is assessed. If the two logins exceed a range for the same city but are in the same province, autonomous region, and/or state, the operation goes to 322. At 322, an assessment is made as to whether the speed of movement between the two logins exceeds a predetermined value (e.g., 120 km/h). If so, the operation goes to 326.

At 324, an assessment is made as to whether the speed of movement between the two logins exceeds a predetermined value (e.g., 900 km/h). If so, the operation goes to 326. At 326, the current multiple location login is determined to be an abnormal login. In some embodiments, the client terminal may be notified, or temporary restrictive measures may be taken automatically.

In some embodiments, the system may confirm the login range for the current login based on the geographic locations of the client acquired for the two logins. The system may acquire the preset speed corresponding to the login range for the current login based on the confirmed login range. For example, as shown in FIG. 3, separate examples for the preset speeds for two login ranges are provided. The system may compare the preset speed with the speed of movement to confirm the validity of the current multiple location login. When the speed of movement exceeds the preset speed, the system may determine or confirm that the current login is an invalid multiple location login.

In some embodiments, when the user logs in, the server system records the login time, IP address, and latitude and longitude for the user. The latitude and longitude may be acquired directly through a geographic location positioning device or by querying an IP geographic location database. In addition, a city associated with the login may be acquired by querying an IP geographic location database, and the province, autonomous region, and/or state may be acquired by querying an IP geographic location database as well. Therefore, using the information recorded for the previous login, the speed of movement along the linear distance between the two login locations may be calculated.

If the two login locations are both in the same city, the speed of movement should not exceed 80 km/h. If the two login locations are not in the same city but are in the same province, autonomous region, and/or state, the speed of movement should not exceed 120 km/h. If the two login locations are not in the same province, autonomous region, and/or state, the speed of movement should not exceed 900 km/h. When any one of these conditions is not met, the multiple location login is deemed to be an abnormal login.

In some embodiments, an assessment is made as to whether a login range of a current login is located within a preset first login range. In these instances, when the login range of the current login is located within the preset first login region, an assessment is made as to whether the speed of movement exceeds a first preset speed. When the speed of movement exceeds the first preset speed, the system confirms that the current multiple location login is an invalid multiple location login. In some embodiments, when the login range is determined to be in the same city, and the speed of movement exceeds 80 km/h, this multiple location login is deemed to be invalid.

In some embodiments, when a login range of a current login is located outside of a preset first login region, an assessment is made as to whether the login range is located at a preset second login region. When the login range of the current login is located within the preset second login region, an assessment is made as to whether the speed of movement exceeds a second preset speed. When this speed of movement exceeds the second preset speed, the system confirms that the current login is an invalid multiple location login. In some embodiments, when the login range is determined to go beyond the same city but to be within the same province, autonomous region, and/or state, reference is made to the preset speed of 120 km/h. If the speed of movement exceeds 120 km/h, this multiple location login is deemed to be invalid.

In some embodiments, a login range of the current login goes beyond the preset second login region, an assessment is made as to whether the speed of movement exceeds a third preset speed. When the speed of movement exceeds the third preset speed, the system confirms that this multiple location login is an invalid multiple location login. In some embodiments, when the login range goes beyond the same city and same province, autonomous region, and/or state, reference is made to the preset speed of 900 km/h. If the speed of movement exceeds 900 km/h, this multiple location login is deemed to be invalid.

In some embodiments, a calculation is conducted as to whether the speed of movement along the linear distance between the two login locations exceeds a preset speed. This preset speed must be set according to related speed limits (e.g., the speed limit on city roads is 80 km/h, the speed limit on highways is 120 km/h, and the maximum speed for civilian aircraft is 900 km/h). If the speed of movement exceeds the related speed limit, the multiple location login is deemed to be an abnormal login. Accordingly, it is necessary to send an alert or prohibit subsequent operations. These preset speeds may be updated based on changes in speed limits.

In some embodiments, the server may also record geographic locations from which the user typically logs in. If there is a login from a geographic location a certain distance away from there, the login may be deemed to be an abnormal login.

In some embodiments, when a user uses Client A to login using a login ID in Beijing and starts a transaction, the geographic location positioning device on Client A acquires the geographic location of Client A at the time of the current login. The device acquires the latitude and longitude of Beijing, and records and stores this information, while also recording the IP address of Client A. After the server acquires this information, it looks up the login information from the previous application logins for this login ID. If the server finds that a previous application login was in the United States, the server calculates the movement speed for the two logins. If the server finds that the speed of movement is 2000 km/h, which far exceeds 900 km/h (assuming that the preset speed for transnational movement is 900 km/h), the current application login and transaction in Beijing may be considered to be an invalid transaction. Accordingly, it is necessary to send an alert or end the transaction.

The current login and previous logins of this disclosure are not limited to adjacent login times. They may also include two logins that are separated by an interval of time. For example, if, during the previous login, there were high-frequency application logins from the same location and same IP address, the average of the multiple login times for the previous login is used as the login time for this client at the previous login.

It should be explained that the steps shown in the drawings and flow diagrams may be executed by a computer system using computer-executable commands. Also, even though the flow diagrams show a logical order, under certain circumstances, the illustrated and described steps may be executed in a different order.

In the preceding description, as opposed to the existing technologies, this disclosure takes geographic location factors into full consideration. If the speed of movement along the linear distance between two consecutive login locations exceeds a speed limit, the current multiple location login is deemed to be an invalid login. The client user may activate security measures based on this information, therefore improving the user experience and ensuring the security of the system.

Obviously, a person skilled in the art should know that the preceding modules and steps of this disclosure may be achieved using common calculation equipment; they may be centralized in a single calculation device, or they may be distributed throughout a network made up of multiple calculation devices. Optionally, they may be achieved using a program code that may be executed by calculation devices. In this way, it is possible to store them in a storage device and execute them using a calculation device, or separately make different integrated circuit modules for them, or take their multiple modules or steps and make a single integrated circuit module. Thus, this disclosure is not limited by any particular hardware and software combination.

The preceding descriptions are merely embodiments of this disclosure and are not used to limit this application. For a person skilled in the art, there are a variety of alterations and changes that could be made to this application. All modifications, equivalent substitutions, and improvements that are in keeping with the spirit and principles of this disclosure shall be included in the scope of protection of this disclosure.

What is claimed is:

1. A computer-implemented method, the method comprising:
receiving, by a server, a first login request that includes a login identification (ID) of a user, a first login time, and a first login geographic location of the user;
obtaining a second login time and a second login geographic location of the user based on a second login request that is previously received and has the login ID; and
calculating a moving rate associate with the user based on the first login time, the first login geographic location, the second login time, and the second geographic location; and
determining a current login invalid in response to a determination that the moving rate is greater than a predetermined value.

2. The computer-implemented method of claim 1, wherein the first login geographic location of the user is determined using a geographic location positioning device associated with the user, or using an Internet Protocol (IP) address and an IP geographic location database.

3. The computer-implemented method of claim 1, wherein the determining the current login invalid comprises:
determining a login range associated with the current login based on the first login geographic location and the second login geographic location;
determining the predetermined value based on the login range; and
determining the current login invalid in response to a determination that the moving rate is greater than the predetermined value.

4. The computer-implemented method of claim 1, wherein the determining the current login invalid comprises:
determining that a login range associated with the current login is within a first predetermined login range; and
determining the current login invalid in response to a determination that the moving rate is greater than a first predetermined value corresponding to the first predetermined login range.

5. The computer-implemented method of claim 1, wherein the determining the current login invalid comprises:
determining that a login range associated with the current login is not within a first predetermined login range;
determining that the login range associated with the current login is within a second predetermined login range; and
determining the current login invalid in response to a determination that the moving rate is greater than a second predetermined value corresponding to the second predetermined login range.

6. The computer-implemented method of claim 1, wherein the determining the current login invalid comprises:
determining that a login range associated with the current login is neither within a first predetermined login range nor a second predetermined login range;
determining that the login range associated with the current login is within a third predetermined login range; and
determining the current login invalid in response to a determination that the moving rate is greater than a third predetermined value corresponding to the third predetermined login range.

7. The computer-implemented method of claim 1, wherein the first login geographic location of the user is determined using a geographic location positioning device that is a Global Positioning System (GPS) chip or a World Wide Web Consortium (W3C) geographic location positioning device.

8. A system for multiple location login control, the system comprising:
one or more processors; and
memory to maintain a plurality of components executable by the one or more processors, the plurality of components comprising:
an acquisition module that receives a first login request that includes a login identification (ID) of a user, a first login time, a first login geographic location of the user,
a query module that obtains a second login time and a second login geographic location of the user based on a second login request that is previously received and has the login ID,
a calculation module that calculates a moving rate associate with the user based on the first login time, the first login geographic location, the second login time, and the second geographic location, and
a processing module that determines a current login invalid in response to a determination that the moving rate is greater than a predetermined value.

9. The system of claim 8, wherein the first login geographic location of the user is determined using a geographic location positioning device associated with the user, or using an Internet Protocol (IP) address and an IP geographic location database.

10. The system of claim 8, wherein the determining the current login invalid comprises:
determining a login range associated with the current login based on the first login geographic location and the second login geographic location;
determining the predetermined value based on the login range; and
determining the current login invalid in response to a determination that the moving rate is greater than the predetermined value.

11. The system of claim 8, wherein the determining the current login invalid comprises:
determining that a login range associated with the current login is within a first predetermined login range; and
determining the current login invalid in response to a determination that the moving rate is greater than a first predetermined value corresponding to the first predetermined login range.

12. The system of claim 8, wherein the determining the current login invalid comprises:
determining that a login range associated with the current login is not within a first predetermined login range;
determining that the login range associated with the current login is within a second predetermined login range; and
determining the current login invalid in response to a determination that the moving rate is greater than a second predetermined value corresponding to the second predetermined login range.

13. The system of claim 8, wherein the determining the current login invalid comprises:
determining that a login range associated with the current login is neither within a first predetermined login range nor a second predetermined login range;
determining that the login range associated with the current login is within a third predetermined login range; and
determining the current login invalid in response to a determination that the moving rate is greater than a third predetermined value corresponding to the third predetermined login range.

14. The system of claim 8, wherein the first login geographic location of the user is determined using a geographic location positioning device that is a Global Positioning System (GPS) chip or a World Wide Web Consortium (W3C) geographic location positioning device.

15. One or more computer-readable media storing computer-executable instructions that, when executed by one or more processors, instruct the one or more processors to perform acts comprising:
receiving an authentication request including an identification (ID) associated with a user, and a time and a location that are associated with a login;
analyzing the ID to obtain an additional login time and an additional location that is associated with an additional authentication request; and
calculating a moving rate associate with the user based on the time, the location, the additional login time, and the additional location; and
rejecting the authentication request in response to a determination that the moving rate is greater than a predetermined value.

16. The one or more computer-readable media of claim 15, wherein the location is determined using a geographic location positioning device or based on an Internet Protocol (IP) address.

17. The one or more computer-readable media of claim 15, wherein the acts further comprising:
determining a login range associated with authentication request based on the location and the additional location; and
determining the predetermined value based on the login range.

18. The one or more computer-readable media of claim 15, wherein the location is determined using a Global Positioning System (GPS) chip or a World Wide Web Consortium (W3C) geographic location positioning device.

19. The one or more computer-readable media of claim 15, wherein the acts further comprise:
determining one or more location types of the location and the additional location, one or more location types include at least one of a city, a state, or a country; and
determining the predetermined value based on the one or more location types.

20. The one or more computer-readable media of claim 15, wherein the acts further comprise:
determining a region that the location and the additional location are within, the region being at least one of a city, a state, or country; and
determining the predetermined value corresponding to the region.
